(19) United States
(12) Patent Application Publication
(10) Pub. No.: US 2013/0096880 A1
(43) Pub. Date: Apr. 18, 2013

(54) SYSTEM TEST METHOD

(71) Applicants: Hyundai Motor Company, Seoul (KR); Kia Motors Corporation, Seoul (KR); Ewha University - Industry Collaboration Foundatio, Seoul (KR)

(72) Inventors: Byoung Ju Choi, Seoul (KR); Joo Young Seo, Seoul (KR); Seung Wan Yang, Gunpo (KR); Jung Suk Oh, Gwangmyeong (KR)

(73) Assignees: HYUNDAI MOTOR COMPANY, Seoul (KR); Ewha University - Industry Collaboration Foundation, Seoul (KR); KIA MOTORS CORPORATION, Seoul (KR)

(21) Appl. No.: 13/693,136

(22) Filed: Dec. 4, 2012

Related U.S. Application Data
(63) Continuation of application No. PCT/KR2010/006068, filed on Sep. 7, 2010.

(51) Int. Cl. G06F 11/34

(52) U.S. Cl. CPC G06F 11/3409
USPC 702/182

(57) ABSTRACT

Disclosed is a test system and method that is configured to identify a position of a process control block, access the position of the process control block, and monitor performance factors related to the process control block.

### CROSS-REFERENCE(S) TO RELATED APPLICATIONS

This application is a continuation of Patent Cooperation Treaty Application No. PCT/KR2010/006068, filed on Sep. 7, 2010, which is incorporated herein by reference in its entirety.

### BACKGROUND

1. Technical Field

The present invention relates to a test system and method.

1. Background

Recently, there has been an increasing interest in electronic control technology even in the machine industry sector, such as vehicles. The core of the electronic control technology is embedded software, and the quality of the software has a great effect on the quality of the entire product.

In the past, software test technology and test tools for helping quality have been developed. However, conventional software test technology and test tools are applied to a test for embedded software without taking into account any of the specific unique characteristics of embedded software.

First, the embedded software is tailored and produced for a specific hardware and function. Most pieces of embedded software are designed so that they are optimized for restrictive conditions in which available system resources, such as memory, are insufficient and are operated. Accordingly, embedded software operating in a target environment has very limited resources when a system is actually operating, as compared with conventional software operating in a host environment.

Second, embedded software is chiefly operated by various types of external inputs, such as electronic signals or communication protocols, rather than by user commands, such as selection of menus. Accordingly, there is a problem in that conventional software test technology and test tools chiefly operated in response to user commands are applied to a test for embedded software without taking into account these characteristics.

Third, in conventional software test technology, only when there is a continuous high processor use rate during testing is this considered a symptom that indicates a performance bottleneck. Accordingly, the components use rate is not considered an abnormal symptom even though its performance has fallen below a basic performance level. Accordingly, there is a problem in that the performance of a system cannot be precisely tested.

### SUMMARY

An embodiment of the present invention is directed to technology related to a test system and method that is configured to collect data for identifying a performance bottleneck, a cause of the bottleneck and the location at which the bottleneck is occurring using the minimum amount of resources necessary for a system to operate without affecting the operational environment of the system.

According to one exemplary embodiment of the present invention, the present invention provides a test system and method that includes identifying a position of a process control block, accessing the position of the process control block, and monitoring the performance factors of the process control block.

Advantageously, the test system and method described herein may be configured using the minimum amount resources necessary for a system to operate without affecting the operational environment of a system. Furthermore, the exemplary embodiment of the present invention may also test the system based upon inputs from outside of the system, and determine whether a use rate of a processor has fallen below a basic level that indicates that a bottle neck has been formed.

### BRIEF DESCRIPTION OF THE DRAWINGS

FIG. 1 is a flowchart illustrating a test system and method according to an exemplary embodiment of the present invention;

FIG. 2 illustrates a program instructions stored on a computer readable medium which are configured to implement the test system and method according to an exemplary embodiment of the present invention; and

FIG. 3 is a diagram showing an exemplary construction of a system for executing the test system and method according to an exemplary embodiment of the present invention.

### DETAILED DESCRIPTION

A system test method of the present invention includes identifying the position of a process control block, accessing the position of the process control block, and monitoring the performance factors of the process control block.

Exemplary embodiments of the present invention will be described more fully hereinafter with reference to the accompanying drawings.

In a system test method according to the present invention, a process control block refers to a data structure that is configured to manage information regarding the execution of processes that are being operated by an Operating System (OS) within a system. For example, the process control block may refer to the data structure of a kernel which manages information regarding the recent execution of processes operated by a system in real time.

The system test method according to the present invention hooks a function table related to a memory through the process control block in order to detect a defect occurring in the memory of a system. In particular, the system test method according to the exemplary embodiment of the present invention may hack pieces of system execution information, such as a page fault rate and a processor use rate, and analyze system performance based on the pieces of system execution information in order to analyze a performance bottleneck, and the cause of the bottleneck in the data of the process control block.

The hacking of the process control block can minimize the reduction in system performance associated with a conventional testing procedure because it concentrates the collection of data necessary for performance analysis on the process control block only. Furthermore, the present invention can minimize a reduction in system performance and, at the same time, satisfy requirements for a performance test in a system operation environment. For example, the system test method according to the present invention may be performed under the following conditions.

System test conditions

1. Test range: a performance test for a system when all hardware and software components within the entire system operate.

2. Test method: a run-time test performed in a non-re-compile, non-re-link, and non-re-execute manner in order to guarantee the system execution method.

3. Test target: a test for a binary code loaded onto a system without changing the original source/binary code of test target software which does not include an additional code, such as debugging information.

4. Performance data: the collection of performance data in which not only a processor, but also memory, I/O devices, and network resources are taken into consideration in order to determine the cause of a performance bottleneck.

5. Tracking of bottleneck position: the collection of data that enables source level analysis, such as a function, in order to determine the position of a performance bottleneck.

6. Hardware independence: a test under the same hardware conditions as those of a system operation environment without additional hardware or dependency on additional hardware for the test.

7. Software independence: a test under the same hardware conditions as those of a system operation environment in which an instrumented kernel or virtual machine for the test is not used.

8. Performance delay rate: the minimization of a system performance delay rate due to a test in order to guarantee a real-time operation.

9. Code addition rate: the minimization of a code addition rate due to a test for the purpose of an operation within limited resources.

It is however noted that the conditions may vary depending on system operation environments and the illustrative embodiment may be applied to various system operation environments without being limited to the above-described system operation environment.

The process control block is a kernel data structure including information about the execution of processes that are operating in a system. The process control block further includes processor usage statistics for identifying the performance bottleneck and performance factors, such as an available memory size. The kernel maintains the latest values of the processor usage and the performance factors.

The test system and method according to the exemplary embodiment of the present invention may be used in performance analysis for the development of an agent who hacks the values. Performance factors necessary to analyze the cause of a performance bottleneck and the structure of a process control block associated with the performance factors are described below.

Performance in the illustrative embodiment of the present invention refers to the degree that a system or components perform functions under restricted conditions in a given system. A performance test is an estimation regarding whether a system satisfies specific performance requirements or not. The performance of a system can be improved by analyzing a performance bottleneck and a cause thereof through the performance test and resolving the performance bottlenecks therein.

A performance bottleneck of a system is a phenomenon in which the performance of a system is deteriorated due to contention for limited resources, such as memory, I/O devices, and network bandwidth. The system performance bottleneck may result from various sources or causes, such as the shortage of resources, contention for shared resources, the exclusive possession of resources, erroneous configurations of resources, and erroneous operations of resources. For example, a performance bottleneck resulting from memory reduction may occur when available memory is insufficient. Core memory performance factors capable of identifying memory shortage symptoms may include a page fault and a memory usage.

The test system and method according to the exemplary embodiment of the present invention may identify a variety of performance bottlenecks. First, the test system and method according to the exemplary embodiment of the present invention may determine a memory bottleneck has occurred based on a page fault. For example, when a page fault count is higher than a normal value, it may correspond to a memory bottleneck. The page fault is a phenomenon occurring when a program attempts to access data or a code which exists in its address space, but does not exist in the memory of a system at the present time. When the page fault occurs, an OS fetches the data or code in the memory and enables the program to continue to operate as if a page fault has not occurred. The exception handling of the OS on a page fault delays the processing time of an application and affects the entire system performance.

Furthermore, the test system and method according to the exemplary embodiment of the present invention may identify a performance bottleneck through the memory usage. The memory of a system includes a physical memory usage and a virtual memory usage and may further include heap memory usage for each process. The system test method according to the exemplary embodiment of the present invention determines a performance bottleneck has occurred based on the sum of the memory usages.

Furthermore, the test system and method according to the exemplary embodiment of the present invention may identify a performance bottleneck based on a processor usage (or a CPU usage). For example, the test system and method according to the present invention may determine that there is a bottleneck in a CPU when the processor usage is higher than a normal value and there is available memory. In contrast, when the processor usage is higher than a normal value and the memory is exhausted, a performance problem may result from a memory bottleneck rather than a CPU bottleneck.

The test system and method according to the exemplary embodiment of the present invention may also identify a performance bottleneck based on process usage. Process usage refers to the time in which an idle time is excluded from the entire CPU usage in the execution time of a system.

Even further, test system and method according to the exemplary embodiment of the present invention may determine a performance bottleneck based on a user time. The user time refers the time for which execution stays in a user space. That is, the time it takes for an application to be executed.

Additionally, the test system and method according to the exemplary embodiment of the present invention may determine a performance bottleneck based on a kernel time. The kernel time refers to the time for which execution stays in a kernel space. That is, the time that it takes for the kernel to process service.

The process control block is a data structure that manages an OS kernel in order to control processes in run-time. In general, pieces of execution information, such as a process ID, register context, the address space of a process, the memory usage of a process, a shared function list, resources shared by processes, and the priority and state of a process, are stored in the process control block.

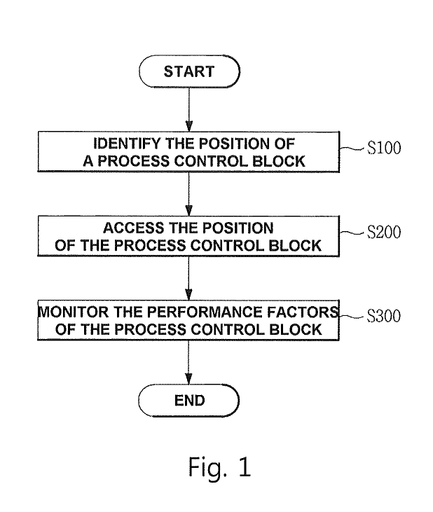

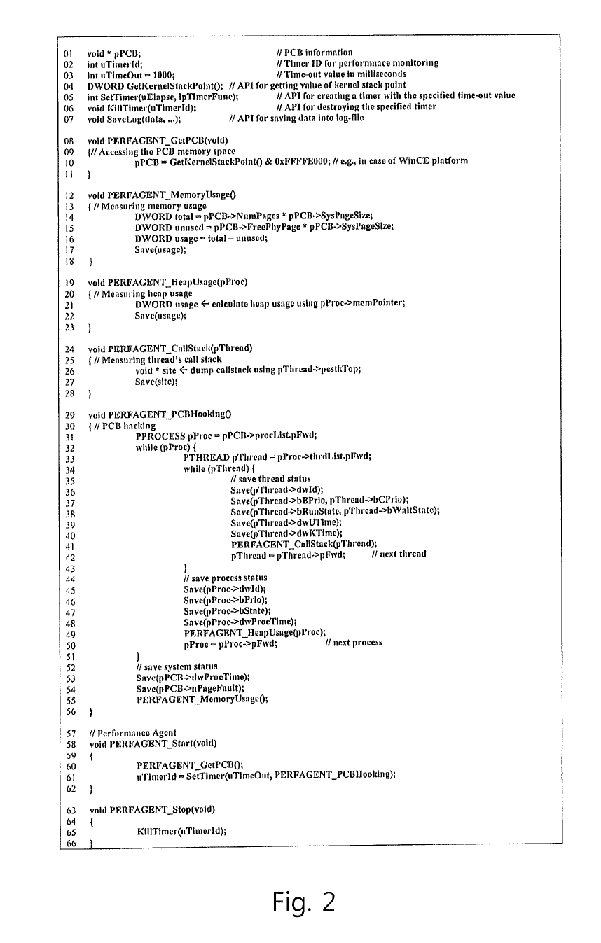

FIG. 1 is a flowchart illustrating a test system and method according to an embodiment of the present invention. FIG. 2 illustrates a program instructions which are stored on non-transitory computer readable media such a disk, or any other storage device for implementing the test system and method according to the exemplary embodiment of the present invention.

Referring to FIG. 1, the test system and method according to the exemplary embodiment of the present invention includes identifying, by a processor configured to execute the method, the position of a process control block at step S100, accessing, by the processor, the process control block at step S200, and monitoring, by the processor, the performance factors of the process control block at step S300.

In identifying the position of the process control block at step S100, the position where a process control block is stored is not determined because the process control block is generated or the process control block disappears when a process is generated or the process disappears. However, information related to the process control block of a current process that occupies a processor (e.g., a CPU) may be known because the base address of a process control block regarding the current process is managed in a specific memory space or managed at a specific fixed address. For example, in the program instructions of FIG. 2, the base address of a process control block regarding a current process may be calculated as a stack pointer like in line 7, and the process control block of all processes may be accessed like in line 31.

In accessing the position of the process control block at step S200, the process control block is placed in the memory space of a kernel. In this case, access to the memory space of the kernel may not be allowed in terms of security. If access to the memory space of the kernel is blocked as described above, pseudo codes may be implemented in the form of a virtual driver so that the address space of the kernel can be shared like in the lower lines of the program code of FIG. 2. Accordingly, a process control block placed in the memory space of the kernel may be accessed.

In the monitoring the performance factors of the program control block at step S300, like in line 61 and line 65 of the program code of FIG. 2, timer-interrupt may be used and performance data may be measured at a predetermined time interval (e.g., 1 sec pr 100 msec). Furthermore, the test system and method according to the exemplary embodiment of the present invention may measure performance factors, while circulating the processes and thread lists of the process control block, like in line 31 and line 33 of the program code of FIG. 2 in order to analyze system performance not only in a system unit, but also in a process or thread unit.

In this case, call-stack information may be stored for each thread in order to precisely track the position at which a system performance bottleneck occurs. Performance factors measured for each monitoring are as follows. The performance factors of the process control block may include one or more of the processor usage, the memory usage, and the page fault. The performance factors of a process of the process control block may include one or more of an identifier (ID), the state of a process, the priority of a process, a heap usage, the operating time of a process, a use time, and a kernel time. The performance factors of a thread of the process control block may include one or more of an ID, a run state, a basic priority, a current priority, a use time, a kernel time, and call-stack information.

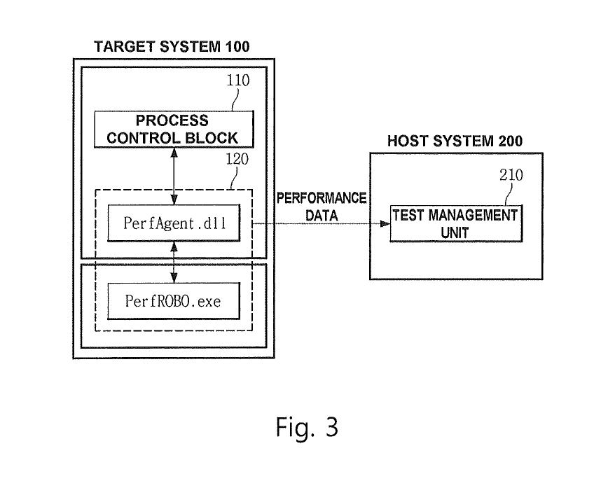

FIG. 3 shows the construction of a system for executing the test system and method according to the present invention. Referring to FIG. 3, the system for executing the test system and method according to the present invention includes an agent unit 120 and a test management unit 210. The agent unit 120 is included in a target system 100, that is, a target of test, and is configured to measure performance data. The agent unit 120 executes the algorithm shown in FIG. 1.

The test management unit 210 is included in a host system 200, such as a Personal Computer (PC) which may execute, for example, a processor. The test management unit 210 analyzes performance data collected by the agent unit 120 and detects a performance bottleneck and analyzes test coverage based on the analyzed performance data. Particularly, the agent unit 120 is mounted on the target system 100 disposed in an operation environment, and it functions to periodically measure data related to system performance when the target system is operated in response to the test start or end command of a user.

For example, the agent unit 120 may include PerfAgent.dll and PerfROBO.exe. PerfAgent.dll is a virtual kernel device driver that implements the algorithm of FIG. 1. The virtual kernel device driver hacks information about the process control block of a kernel for the purpose of a performance test. PerfROBO.exe functions as a test server for controlling whether to activate the virtual kernel device driver in response to the test start or end command of a user. Both of these drivers may be executed by the processor.

The test server executes a system performance monitoring module through timer setting when the virtual kernel device driver (e.g., PerfAgent.dll) is activated in response to the test start command and terminates a test by finishing a set timer when the test is finished at the request of a user.

Meanwhile, the test management unit 210 may store the collected performance data in a designated storage medium. The test management unit 210 functions to analyze the log file of the host system 200 and detect a performance bottleneck occurred in run-time based on the analyzed log file. For example, if the test management unit 210 stores performance data in a storage medium in the form of a binary code, the test management unit 210 may use a binary execution code and collected profiling data for a test target as input and display information about the position of a problematic function based on call-stack information when outputting test coverage and performance information.

In the test system and method according to the exemplary embodiment of the present invention, various methods of monitoring the performance of a system may be used. First, a method of inserting an analysis code into a kernel may be used.

In this method, the analysis code is inserted into the kernel statically or dynamically. In the method of inserting the analysis code into the kernel dynamically, an analysis code may be inserted into a kernel code in run-time. In this case, a code for collecting data necessary for performance analysis can be inserted without booting a system.

In the method of inserting the analysis code into the kernel statically, a previously produced kernel is used. For example, an analysis code for monitoring important system performance factors may be embedded in a kernel. In the case of performance monitoring, performance data is received through the analysis code previously inserted into the kernel. In this case, when performance is monitored, a variety of system performance factors, including a processor usage and a memory usage, can be measured.

Furthermore, a method using a simulator may be used as the performance monitoring method. This method is useful to check the performance of a system at the early stage of development. Furthermore, hardware may be used as the performance monitoring method. Hardware performance factors refer to a set of specifically produced registers. If the hardware performance factors are used, performance associated with a CPU, a cache, and memory can be monitored using system overhead lower than that of software-based performance factors. In this method, a source code or a binary code needs not to be modified.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The exemplary embodiment of the present invention is configured to test a system using only the resources necessary without affecting the operation environment of the system.

1. A method for testing performance of a system, comprising:
identifying, by a processor, a position of a process control block;
accessing, by the processor, the position of the process control block; and
monitoring, by the processor, performance factors related to the process control block.

2. The method of claim 1, wherein the process control block is placed in kernel memory.

3. The method of claim 2, wherein the accessing-the-position-of-the-process-control-block comprises accessing the kernel memory using a virtual driver.

4. The method of claim 1, wherein the monitoring-performance-factors-of-the-process-control-block comprises measuring the performance factors of the process control block at a predetermined time interval.

5. The method of claim 2, wherein the monitoring-performance-factors-of-the-process-control-block comprises measuring the performance factors for a process and thread of the process control block.

6. The method of claim 5, wherein the performance factors of the process control block comprise one or more of a processor usage, a memory usage, and a page fault.

7. The method of claim 6, wherein the performance factors of the process of the process control block comprise one or more of an identifier (ID), a state of the process, a priority of the process, a heap usage, an operating time of the process, a use time, and a kernel time.

8. The system test method of claim 6, wherein the performance factors of the thread of the process control block comprise one or more of an ID, a run state, a basic priority, a current priority, a use time, a kernel time, and a call-stack.

9. The system test method of claim 1, wherein the process control block stores one or more of pieces of information about an ID of a process, register context, an address of the process, a memory usage, a shared function list, resources of the process, a priority of the process, and a state of the process.

10. The system test method of claim 1, wherein the monitoring-performance-factors-of-the-process-control-block comprises monitoring the performance factors of the process control block by inserting an analysis code into a kernel.

11. The system test method of claim 1, wherein the monitoring-performance-factors-of-the-process-control-block comprises monitoring the performance factors of the process control block using a simulation program.

12. The system test method of claim 1, wherein the monitoring-performance-factors-of-the-process-control-block comprises monitoring the performance factors of the process control block using hardware including registers.

13. A system comprising:
a host system including:
a memory configured to store one or more data structures; and
a processor, the processor configured to identify a position of a process control block, access the position of the process control block, and monitor performance factors related to the process control block.

14. The system of claim 1, wherein the process control block is placed in kernel memory.

15. A non-transitory computer readable medium containing program instructions executed by a processor, the computer readable medium comprising:
program instructions that identify a position of a process control block;
program instructions that access the position of the process control block; and
program instructions that monitor performance factors related to the process control block.
